(19) United States
(12) Patent Application Publication
(10) Pub. No.: US 2015/0240049 A1
(43) Pub. Date: Aug. 27, 2015

(54) METHOD FOR GRINDING A PARTICULATE INORGANIC MATERIAL

(71) Applicant: IMERYS TALC EUROPE, Toulouse (FR)

(72) Inventor: Anthony Hiorns, St. Austell Cornwall (GB)

(21) Appl. No.: 14/432,521

(22) PCT Filed: Oct. 1, 2013
(86) PCT No.: PCT/EP2013/070467

§ 371 Date: Mar. 31, 2015

(30) Foreign Application Priority Data
Oct. 2, 2012 (EP) 12290328.9

(51) Int. Cl. C08K 3/34; C08K 3/26

(52) U.S. Cl. CPC C08K 3/346; C08K 3/26; C08K 3/34; C08K 2003/265

(57) ABSTRACT

A method for grinding a particulate inorganic material may include: (i) providing an aqueous suspension including a mixture of a particulate alkaline earth metal carbonate material and a particulate phyllosilicate mineral having a shape factor less than 60; and (ii) grinding the aqueous suspension to form a ground product.

### FIELD OF THE INVENTION

The present invention relates to a method of grinding an aqueous suspension of a particulate inorganic material comprising a mixture of a particulate alkaline earth metal carbonate material and a particulate phyllosilicate mineral, and to products obtained thereby.

### BACKGROUND OF THE INVENTION

Aqueous suspensions containing mixtures of particulate alkaline earth metal carbonate material, such as calcium carbonate, and platy minerals or pigments, such as the particulate phyllosilicate mineral kaolin, are used widely in a number of applications. These include, for example, the production of pigment or filler containing compositions which may be used in paper manufacture or paper coating, and the production of compositions for paints, plastics and the like.

In preparing products for industrial use, both of these natural materials are processed, typically by grinding an aqueous suspension of each material in the presence of a hard grinding media (e.g. ceramic spheres or sand). The natural sources of platy minerals typically comprise stacks of individual particles or plates, where the individual particles (plates) of the stacks are weakly bound to each other. These stacks are created by chemical processes during the process when the pigments are created (e.g. kaolin is produced by the weathering of clays or feldspar in hot, moist conditions). In preparing products for industrial use, these natural materials are processed, typically by grinding an aqueous suspension of the material in the presence of a hard grinding media (e.g. ceramic spheres or sand).

A present practice is to process the raw alkaline earth metal carbonate material and the raw particulate phyllosilicate mineral separately, for example, by processing the raw alkaline earth metal carbonate material by grinding at a solids content of 65% and above, and processing the particulate phyllosilicate mineral by grinding at a solids content of about 30%. This low solids content grinding of, for example, kaolin favours delamination of the particles, and so results in an increase in the particle shape factor.

### SUMMARY OF THE INVENTION

In a first aspect, there is provided a method for grinding a mixture of particulate inorganic materials, comprising:
(i) providing an aqueous suspension comprising a mixture of a particulate alkaline earth metal carbonate material and a particulate phyllosilicate mineral having a shape factor less than 60; and
(ii) grinding the aqueous suspension to form a ground product.

In a second aspect, the invention also relates to a ground mineral obtained or obtainable by a method according to the first aspect of the invention.

In a third aspect, the invention also relates to a ground particulate material comprising an alkaline earth metal carbonate and kaolin, wherein the calcium carbonate has a d₅₀ in the range of from 0.1 to 5 μm and the kaolin has a d₅₀ in the range of from 0.1 to 5 μm and a shape factor of from 5 to 100

In a fourth aspect, the invention relates to a ground particulate material comprising an alkaline earth metal carbonate and talc, wherein the calcium carbonate has a d₅₀ in the range of from 0.1 to 5 μm and the talc has a d50 in the range of from 0.5 to 10 μm and a shape factor of from 10 to 150, or 10 to 100.

### BRIEF DESCRIPTION OF THE FIGURES

FIGS. 1 and 2 set forth the sheet gloss results obtained in Comparative Example 9 and Example 10.

### DETAILED DESCRIPTION

The present invention provides the aspects mentioned above. Optional and preferred features and embodiments of the aspects are described below. Unless otherwise stated, any optional or preferred feature or embodiment may be combined with any other optional or preferred feature or embodiment of the invention mentioned herein.

Particle size characteristics described herein are measured via sedimentation of the particulate material in a fully dispersed condition in an aqueous medium using a Sedigraph 5100 particle size analyzer supplied by Micrometrics Instruments Corporation Norcross, Ga. USA. The Sedigraph 5100 provides measurements and a plot of the cumulative percentage by weight of particles having a size referred to in the art as the “equivalent spherical diameter” (esd).

“Shape factor”, as used herein, is a measure of the ratio of particle diameter to particle thickness for a population of particles of varying size and shape as measured using the electrical conductivity methods, apparatuses, and equations described in U.S. Pat. No. 5,576,617, which is incorporated herein by reference. As the technique for determining shape factor is further described in the '617 patent, the electrical conductivity of a composition of an aqueous suspension of orientated particles under test is measured as the composition flows through a vessel. Measurements of the electrical conductivity are taken along one direction of the vessel and along another direction of the vessel transverse to the first direction. Using the difference between the two conductivity measurements, the shape factor of the particulate material under test is determined.

The term “d₅₀” used herein refers to the median particle diameter and is the particle diameter at which 50% by weight of the product is larger and 50% by weight is smaller.

The “steepness” of a particle size distribution, as referred to herein is calculated by 100× d₃₀/d₇₀ (d₃₀ is the size at which 30% by weight of the product is larger and 70% is smaller, d₇₀ is the size at which 70% by weight is larger and 30% is smaller).

Surprisingly, certain embodiments of the co-grinding process result in different particle size distributions and shape factors in the resultant minerals as compared to the when the minerals are ground individually (i.e., single-or solo-ground). For instance, when comparing single-ground kaolin to kaolin co-ground with the calcium carbonate, a greater effect on the particle size distribution (e.g., fineness and steepness) is seen as compared to when it is ground on its own. This effect may be associated with the breaking of kaolin plates as there is a general trend towards lower shape factors during co-grinding. In other embodiments, where calcium carbonate is co-ground with talc, the talc is finer and has a lower shape factor than talc ground individually using the same process.

In addition, the method of the first aspect of the invention, results in the shape factor of the phyllosilicate mineral in the ground product, as compared to the shape factor of the phyllosilicate mineral contained in the aqueous suspension provided in step (i), may be being reduced, or may stay the same, or may be increased.

Thus, according to one embodiment, the phyllosilicate mineral is kaolin and the grinding is carried out such that the shape factor of the kaolin in the ground product is reduced. In this embodiment, the d₅₀ of the kaolin may be reduced in the grinding step by at least 20%, or at least 30% or by at least 40% or by at least 50%.

According to another embodiment, the phyllosilicate mineral is talc and the grinding is carried out such that the shape factor of the talc in the ground product is increased. In this embodiment, the d₅₀ of the talc may be reduced in the grinding step by at least 40%, or at least 50% or by at least 60%.

According to yet another embodiment, the phyllosilicate mineral is talc and the grinding is carried out such that the shape factor of the talc in the ground product is reduced. In this embodiment, the d₅₀ of the talc may be reduced in the grinding step by at least 20%, or at least 30% or by at least 40%.

Particulate Alkaline Earth Metal Carbonate Material

The particulate alkaline earth metal carbonate material used in certain embodiments of the present invention may be selected from the carbonate of any metal belonging to Group II of the Periodic Table, for example the carbonates of beryllium, magnesium, calcium and strontium. In certain embodiments, the particulate alkaline earth metal carbonates are magnesium carbonate (e.g. dolomite) and calcium carbonate (e.g. ground natural calcium carbonated such as marble or precipitated calcium carbonate). In one embodiment, the particulate alkaline earth metal carbonate is calcium carbonate.

The particulate alkaline earth metal carbonate material may have a d₅₀ in the range of from 0.5 to 5 μm, for example in the range of from 0.6 to 3.5 μm, for example in the range of from 0.7 to 3.2 μm.

The alkaline earth metal carbonate may have a steepness in the range of from 25 to 50, or from 30 to 50, or from 30 to 45, or from 35 to 45.

Particulate Phyllosilicate Mineral

In certain embodiments, the particulate phyllosilicate mineral used in the present invention may be selected from kaolin, talc and mica. In one embodiment, a single particulate phyllosilicate mineral is used in order to produce a ground material. For example, the single particulate phyllosilicate mineral may be kaolin or the single particulate phyllosilicate mineral may be talc. In another embodiment, a mixture of two or more particulate phyllosilicate minerals may be ground together (i.e., co-ground). For example, a mixture of kaolin and talc may be co-ground together with the particulate alkaline earth metal carbonate material using certain embodiments of the methods of the invention.

The shape factor of the particulate phyllosilicate mineral in the aqueous suspension is less than 60, for example less than 50, or less than 40, or less than 30, or less than 20, or less than 15. The shape factor of the particulate phyllosilicate mineral may be greater than 5, or may be greater than 10, or may be greater than 15. In one embodiment, the particulate phyllosilicate mineral is talc having a shape factor of from 15 to 40, or from 15 to 25. In another embodiment, the particulate phyllosilicate mineral is a kaolin having a shape factor of from 5 to 60, or from 10 to 50, or from 10 to 40, or from 10 to 30.

Where the particulate phyllosilicate mineral is kaolin, it may have a d₅₀ in the range of from 0.3 to 10 μm, for example in the range of from 0.3 to 5 μm, for example in the range of from 0.4 to 4.4 μm. The steepness value of kaolin used as the particulate phyllosilicate mineral may be in the range of from 5 to 60, or from 10 to 50, or from 10 to 40, or from 20 to 40, or from 25 to 35.

In one embodiment, the particulate phyllosilicate mineral is kaolin having a shape factor of from 5 to 60 and a d₅₀ in the range of from 0.3 to 10 μm.

In another embodiment, the particulate phyllosilicate mineral is kaolin having a shape factor of from 10 to 50 and a d₅₀ in the range of from 0.4 to 4.4 μm.

Where the particulate phyllosilicate mineral is talc, it may have a d₅₀ in the range of from 2 to 20 μm, for example in the range of from 2 to 15 μm, for example in the range of from 2 to 10 μm, for example in the range of from 3 to 9 μm. The steepness value where the particulate phyllosilicate mineral is talc may be in the range of from 20 to 55, or from 25 to 50.

The talc may have a whiteness of at least about 50, or at least about 60 or at least about 70, as measured using a Minolta Chroma meter CR300 using illuminant D65 and a measurement geometry of 2°.

The talc may have a particle size distribution such that no more than 50% by weight of the particles are smaller than 2 μm. In an embodiment the talc may have a particle size distribution such that no more than 40% by weight of the particles are smaller than 2 μm. In another embodiment, the talc may have a particle size distribution such that no more than 35% by weight of the particles are smaller than 2 μm. In another embodiment, the talc may have a particle size distribution such that no more than 25% by weight of the particles are smaller than 2 μm. In another embodiment, the talc may have a particle size distribution such that no more than 15% by weight of the particles are smaller than 2 μm.

In one embodiment, the particulate phyllosilicate mineral is talc having a shape factor of from 5 to 50 and a d₅₀ in the range of from 2 to 20 μm.

In another embodiment, the particulate phyllosilicate mineral is talc having a shape factor of from 5 to 35 and a d₅₀ in the range of from 3 to 9 μm.

The particulate phyllosilicate mineral used in certain embodiments of the invention may be a prepared from the raw natural material by one or more pre-processing steps. For example, the raw material may be processed in aqueous suspension to remove contaminants and impurities, for example by magnetic separation. The raw material may also be bleached using methods known to those skilled in the art. The raw material may also be subjected to a preliminary process to reduce the particle size of the agglomerated raw material. For example, the raw material may be ground or milled to reduce the particle size to the desired feed material particle size. In certain embodiments where the phyllosilciate mineral is talc, the feed material may be subjected to an initial dry grinding step. In other embodiments where the phyllosilciate mineral is kaolin, the feed material may be subjected to an initial wet grinding step.

The Feed Particulate Inorganic Material

The feed particulate inorganic material comprises the particulate alkaline earth metal carbonate material and the particulate phyllosilicate mineral.

The ratio of alkaline earth metal carbonate material to particulate phyllosilicate mineral may be from 95:5 to 5:95, for example from 90:10 to 50:50, for example from 90:10 to 60:40, for example from 85:15 to 55:45, or for example from 75:25 to 65:35.

In one embodiment, the particulate phyllosilicate mineral is talc and the ratio of alkaline earth metal carbonate material to talc is from 65:35 to 85:15, for example the ratio is 75:25. In another embodiment the alkaline earth metal carbonate is calcium carbonate.

In one embodiment, the particulate phyllosilicate mineral is kaolin and the ratio of alkaline earth metal carbonate material to kaolin is from 95:5 to 45:55, or from 95:5 to 65:35, or from 95:5 to 75:25, or from 90:10 to 80:20 In another embodiment the alkaline earth metal carbonate is calcium carbonate.

In the first aspect of the present invention, the feed particulate inorganic material is present in the aqueous suspension in an amount of at least 25% by weight, or at least 30% by weight, or at least 45% by weight, or at least 50% by weight, or at least 55% by weight, or at least 60% by weight, or at least 65% by weight. In certain embodiments, the feed particulate inorganic material is present in an amount no more that 75 wt %. In one embodiment, the particulate inorganic material is present in the aqueous suspension in an amount of from 60 to 75 wt %, for example in an amount of from 45% to 72%.

The suspension comprising the coarse, pre-processed feed particulate inorganic material may then be dewatered by, for example, use of a tube press, although other methods of dewatering are also contemplated, such as thermal or spray drying. In certain embodiments, the dewatered product may have a suitable solids content corresponding to that desired for the grinding stage. In alternate embodiments, the dewatered product may be dispersed using a suitable dispersing agent.

Suitable dispersing agents are chemical additives capable, when present in a sufficient amount, of acting on the particles of the particulate material to prevent or effectively restrict flocculation or agglomeration of the particles to a desired extent, according to normal processing requirements. The dispersant may be present in levels up to about 1% by weight, and includes, for example, polyelectrolytes such as polyacrylates and copolymers containing polyacrylate species, especially polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine and other reagents commonly used for this function. The dispersant may, for example, be selected from conventional dispersant materials commonly used in the processing and grinding of inorganic particulate materials. Such dispersants will be well recognised by those skilled in this art. They are generally water-soluble salts capable of supplying anionic species which in their effective amounts can adsorb on the surface of the inorganic particles and thereby inhibit aggregation of the particles. The unsolvated salts suitably include alkali metal cations such as sodium. Solvation may in some cases be assisted by making the aqueous suspension slightly alkaline. Examples of suitable dispersants include: water soluble condensed phosphates, e.g., polymetaphosphate salts [general form of the sodium salts: (NaPO3)×] such as tetrasodium metaphosphate or so-called “sodium hexametaphosphate” (Graham's salt); water-soluble salts of polysilicic acids; polyelectrolytes; salts of homopolymers or copolymers of acrylic acid or methacrylic acid, or salts of polymers of other derivatives of acrylic acid, suitably having a weight average molecular mass of less than about 20,000. Sodium hexametaphosphate and sodium polyacrylate, the latter suitably having a weight average molecular mass in the range of about 1,500 to about 10,000, are especially preferred.

Grinding of the Aqueous Suspension

The aqueous suspension of feed particulate inorganic material is subjected to grinding. Grinding is desirably carried out by attrition using a particulate grinding medium. Alternatively, the suspension may be ground by autogenous grinding, i.e. in the absence of a grinding medium.

The particulate grinding medium, when present, may be of a natural or a synthetic material. The grinding medium may, for example, comprise balls, beads or pellets of any hard mineral, ceramic or metallic material; such materials may include, for example, alumina, zirconia, zirconium, silicate, aluminium silicate or the mullite-rich material which is produced by calcining kaolinitic clay at a temperature in the range of from about 1300° C. to about 1800° C. Alternatively, particles of natural sand of a suitable particle size may be used.

The grinding may be carried out in one or more stages. For example, the feed suspension may be partially ground in a first attrition grinder, the suspension of partially ground inorganic particulate material then being fed to a second attrition grinder for further grinding, after which the suspension of ground material may be fed to one or more subsequent attrition grinders.

Further doses of dispersing agent may be added during grinding as required to maintain a fluid suspension.

The grinding energy imparted during grinding may be at least 25 kWh/t, for example at least 50 kWh/t, at least 100 kWh/t, at least 150 kWh/t, at least 200 kWh/t, at least 250 kWh/t, at least 300 kWh/t, or at least 500 kWh/t.

After completion of grinding, any grinding medium may be removed, and the product suspension may be dewatered, if required.

Grinding may be carried out in a suitable grinding device. In embodiments, the grinding device may be an open grinder having a vertical axis, without recirculation of the suspension. By way of example, the grinding device may be a tumbling mill (e.g., rod, ball and autogenous), a stirred mill (e.g., SAM, GK grinder or IseMill), or a screened grinder such as a stirred media detritor (SMD), or a tower mill.

In one embodiment, an aqueous suspension containing the alkaline earth metal carbonate material is subjected to grinding, and the particulate phyllosilicate mineral is added later while the grinding is already occurring, i.e. the particulate phyllosilicate mineral is added during the grinding process. Addition of the particulate phyllosilicate mineral at different points in the process depends on the desired properties of the particulate phyllosilicate mineral.

If the particulate phyllosilicate mineral is already quite close to the target particle size distribution and it has not previously been ground, then the particulate phyllosilicate mineral can be added quite late in the grinding process. If the particle size distribution of the particulate phyllosilicate mineral is required to change significantly, then the particulate phyllosilicate mineral can be added earlier in the alkaline earth metal carbonate material grinding process, or also with the alkaline earth metal carbonate flour.

In one embodiment, the inorganic particulate material (or, alternatively, the particulate phyllosilicate mineral and the alkaline earth metal carbonate material) is ground in a cascade of grinders (for example, between 2 to 4 grinders, where the output of one grinder feeds into the next grinder).

If the particulate phyllosilicate mineral is to be added late in the grinding process, this could be to the last or second-to-last grinder in the cascade. If the particulate phyllosilicate mineral is to be added early in the grinding process, this could be to the first grinder in the cascade.

Ground Inorganic Material Product

The particulate phyllosilicate mineral in the ground product obtained by grinding the aqueous suspension of particulate inorganic material has an increased shape factor compared to the feed material. The shape factor may be increased by at least 50% or at least 100%. In certain embodiments, the increased shape factor will be less than 100, or less than 90 or less than 80 or less than 70.

Where the particulate phyllosilicate mineral comprises kaolin, the shape factor of the kaolin in the product is greater than the shape factor of the kaolin in the feed material, and is in the range of 5 to 100, for example in the range of 5 to 80, for example in the range of 8 to 76, for example in the range of 10 to 70, for example in the range of 20 to 60, for example in the range of 30 to 50.

Where the particulate phyllosilicate mineral comprises talc, the shape factor of the talc in the product is greater than the shape factor of the talc in the feed material, and is in the range of 10 to 100, for example in the range of 10 to 70, for example in the range 15 to 60, for example in the range 20 to 55, for example in the range of 20 to 53, for example in the range of 25 to 50, for example in the range of 30 to 45.

Where the particulate phyllosilicate mineral comprises kaolin, the d₅₀ of the kaolin in the product is, for example in the range of from 0.1 to 5 μm, for example in the range of from 0.1 to 3 μm, for example in the range of from 0.2 to 2.5 μm.

Where the phyllosilicate mineral comprises talc, the d₅₀ of the talc in the product is, for example in the range of from 0.5 to 10 μm, for example in the range of from 1 to 5 μm, for example in the range of from 1.0 to 2.2 μm.

In order to determine particle size and shape factor properties of the phyllosilicate mineral in the product, the alkaline earth metal carbonate component is removed by dissolving in acid (eg HCl) and washing the remaining product until it is free of excess ions. The particle size distribution of the alkaline earth metal carbonate component of the ground product can be determined based on measurements made on the co-ground blend and the measurements performed on the separated phyllosilicate component.

The solids content of the aqueous suspension resulting after grinding will be determined by the solids content of the aqueous suspension of feed material. Because of evaporation of water during grinding, the solids content of the aqueous suspension resulting after grinding may be higher than that of the feed material, unless additional water is added during grinding to maintain a desired solids content.

The ground phyllosilicate mineral obtained by certain embodiments of the methods of the present invention are another aspect of the invention. Thus, certain embodiments of the present invention also provides a particulate kaolin, optionally in aqueous suspension, having a d₅₀ in the range of from 0.1 to 5 μm and an shape factor of from 5 to 100, for example a d₅₀ is in the range of from 0.2 to 2.5 μm and an shape factor is in the range of from 8 to 76. In certain embodiments, the invention also provides a particulate talc, optionally in aqueous suspension, having a d₅₀ in the range of from 0.5 to 10 μm and an shape factor of from 10 to 100, for example a d₅₀ in the range of from 1.0 to 2.2 μm and the shape factor is in the range of from 20 to 53.

The particulate alkaline earth metal carbonate material in the ground product obtained by grinding the aqueous suspension of particulate inorganic material can have a d₅₀ of from 0.1 to 5 μm, for example in the range of from 0.2 to 3 μm, for example in the range of from 0.3 to 2.5 μm.

Uses of the Ground Particulate Material

The ground particulate material obtained using certain embodiments of the methods of the present invention may be used in a wide variety of applications, as will be readily apparent to one of ordinary skill in this art. In certain embodiments, the inorganic particulate material is present as a coating pigment or filler, or as part of a coating or filler composition. The applications include, for example, the preparation of: paper (which term includes within its scope all forms of paper, card, board, cardboard and the like, including without limitation printing paper and writing paper); polymers and rubbers, e.g. plastics (which may be in the form of a. film); paints; sealants and mastics; ceramics; as well as compositions which are subsequently processed to obtain any of the above.

In one particular embodiment, the co-ground particulate material obtained in accordance with the present invention is made up into a paper coating composition and coated onto a base paper to make a coated paper product, such as a LWC paper product. The coated paper may have a sheet gloss of at least 50, or at least 52, or at least 55, or at least 57, or at least 60. Sheet Gloss is measured using TAPPI 75° (T 480 om-09). The coated paper may have a roughness as measured by PPS-1000 of from 0.90 to 1.05 μm, or from 0.94 to 0.99 μm. The coated paper may have a brightness (+UV) (D65 illumination, ISO 2469) of from 75 to 85, or from 80 to 83. The coated paper may have a DIN opacity (−UV) of from 80 to 90, or from 85 to 88.

Particular embodiments of the present invention will now be described with reference to the following non-limiting Examples and the accompanying drawings.

### EXAMPLES

### Example 1

Various feed kaolins having the characteristics shown in Table 1, were prepared into fully dispersed aqueous suspensions comprising 65 wt % solids and attrition co-ground with a relatively coarse calcium carbonate, using a small pot lab grinder and an energy input of 240 kWh/t. Kaolin fractions of 10%, 20% and 40% by weight were tested. The results obtained are set forth in Table 1 below.

TABLE 1

| | | | | | | | | GCC (Calcium | |
|---|---|---|---|---|---|---|---|---|---|
| | Initial Pigment | | | Kaolin in | | | | Carbonate) in | |
| | Properties | | | Co-ground Blend | | | | Co-ground Blend | |
| | d₅₀ | Shape | | Kaolin | d₅₀ | Shape | | d₅₀ | |
| | (μm) | Factor | Steepness | (%) | (μm) | Factor | Steepness | (μm) | Steepness |
| Kaolin 1 | 0.40 | 20 | 37 | 10 | 0.21 | 16 | 38 | 0.68 | 36 |
| | | | | 20 | 0.25 | 16 | 40 | 0.80 | 41 |
| | | | | 40 | 0.30 | 28 | 41 | 0.76 | 51 |
| Kaolin 2 | 0.51 | 16 | 29 | 10 | 0.19 | 11 | 30 | 0.65 | 34 |
| | | | | 20 | 0.25 | 18 | 31 | 0.79 | 39 |
| | | | | 40 | 0.30 | 20 | 33 | 0.92 | 51 |
| Kaolin 3 | 0.86 | 11 | 21 | 10 | 0.33 | 10 | 27 | 0.63 | 33 |
| | | | | 20 | 0.36 | 14 | 34 | 0.74 | 40 |
| | | | | 40 | 0.38 | 24 | 39 | 0.81 | 51 |
| Kaolin 4 | 2.10 | 17 | 31 | 10 | 0.48 | 11 | 29 | 0.66 | 34 |
| | | | | 20 | 0.52 | 38 | 24 | 0.72 | 36 |
| | | | | 40 | 0.62 | 45 | 20 | 0.88 | 43 |
| Kaolin 5 | 0.56 | 12 | 36 | 10 | 0.33 | 8 | 39 | 0.61 | 32 |
| | | | | 20 | 0.39 | 8 | 34 | 0.69 | 35 |
| | | | | 40 | 0.43 | 11 | 36 | 0.75 | 43 |
| CC1 | 1.45 | — | 28 | — | — | — | — | 0.50 | 28 |

### Example 2

This example shows the effect of addition of kaolin at different points in a cascade grinding process of the type in which calcium carbonate is ground in a series of grinders with the output of one grinder goes to the next grinder. Experiments were conducted to attrition grind 30% of Kaolin 3 with 70% calcium carbonate as per the method above. Three different calcium carbonate materials were used, namely CC1 (see Table 1 above), CC2 and CC3. CC1 was selected to represent the calcium carbonate product obtained from a first grinder in a cascade grinding process and has a particle size distribution such that 60% by weight of particles are smaller than 2 μm, CC2 was a calcium carbonate material selected to have a finer particle size distribution (i.e. 75 wt % of particles smaller than 2 μm) than CC1 and to be representative of a calcium carbonate product obtained from the second grinder in the cascade grinding process, and CC3 was a calcium carbonate material selected to have a finer particle size distribution (i.e. 90 wt % of particles smaller than 2 μm) than CC2 and to be representative of a calcium carbonate product obtained from the third grinder in the cascade grinding process. The experiments thus mimic the effect of adding the kaolin to the second grinder (when ground with CC1), the third grinder (when ground with CC2) and fourth grinder (when ground withCC3) in the cascade. The results obtained are set forth in Table 2 below.

TABLE 2

| | | | | Kaolin Component of | | | GCC Component of | |
|---|---|---|---|---|---|---|---|---|
| | Grinding | Co-ground Blend | | Co-ground Blend | | | Co-ground Blend | |
| | Energy | d₅₀ | | d₅₀ | | Shape | d₅₀ | |
| Initial | (kWh/t) | (μm) | Steepness | (μm) | Steepness | Factor | (μm) | Steepness |
| CC1 | 241 | 0.61 | 33 | 0.31 | 41 | 26 | 0.78 | 44 |
| CC2 | 231 | 0.59 | 33 | 0.34 | 38 | 30 | 0.74 | 40 |
| CC3 | 208 | 0.52 | 34 | 0.37 | 39 | 29 | 0.60 | 36 |

The results show that adding the kaolin at a later stage in a cascade grinding process gives a co-ground blend in which the kaolin component is coarser and the calcium carbonate is finer and slightly less steep.

### Example 3

The paper properties of papers which had been prepared using a laboratory helicoater employing coating compositions based on different pigment blends were evaluated. The pigment blends used and the paper properties obtained are set forth in Table 3 below.

TABLE 3

| | 1 | 2 | 3 | 4 |
|---|---|---|---|---|
| CC4 | 70 | 70 | | |
| Kaolin 6 | | 30 | | |
| CC1 Ground @ 200 | | | | |
| kWh/t | | | | |
| 70/30 CC1/Kaolin 6 | | | 100 | |
| GF Co-ground @ | | | | |
| 200 kWh/t | | | | |
| 70/30 CC1/Kaolin 6 | | | | 100 |
| GF Co-ground @ | | | | |
| 300 kWh/t | | | | |
| Sheet Gloss | 64.0 | 56.0 | 53.0 | 57.0 |
| PPS-1000 (μm) | 0.98 | 1.04 | 0.94 | 0.99 |
| Brightness (−UV) | 81.2 | 81.6 | 81.0 | 80.8 |
| Opacity (−UV) | 85.4 | 85.8 | 87.0 | 86.6 |
| Coating S at | 690 | 830 | 900 | 840 |
| 457 nm | | | | |
| Coating S at | 480 | 620 | 720 | 650 |
| 557 nm | | | | |
| Coating K at | 16.5 | 17.0 | 22.0 | 21.5 |
| 457 nm | | | | |
| Coating K at | 7.0 | 6.0 | 10.5 | 10.0 |
| 557 nm | | | | |

CC4 is a ground calcium carbonate having a particle size distribution such that 95 wt % of particles are smaller than 2μm.

Co-grinding of Kaolin 6 GF (grinder feed) with coarse calcium carbonate (CC1) can give similar coating performance compared to a CC4/Kaolin 6 blend. To achieve this performance, more grinding energy is required compared to just grinding CC1 to CC4 (35 to 50%).

In addition, the co-ground CC1/Kaolin 6 GF has higher opacity, but lower brightness compared to the CC4/Kaolin 6 blend. This is because the Kaolin 8 GF has not been magnetted, leached and classified.

Further, S&K calculations indicate that the coating layers containing the co-ground blends of CC1 and Kaolin 6 GF have slightly higher light scatter but also much higher light absorption compared to CC4/Kaolin 6.

The printability of co-ground CC1/Kaolin 6 GF is similar to CC4/Kaolin 6, apart from much slower ink setting.

### Example 4

A further kaolin, identified as Kaolin 7 was attrition ground with and without calcium carbonate, and having the characteristics shown in Table 4, was evaluated for use as a laboratory coating. The results obtained are set forth in Table 4 below.

TABLE 4

| | Grind Energy | | | |
|---|---|---|---|---|
| | (kWh/t) | d₅₀ (μm) | Shape Factor | Steepness |
| 100% | 0 | 0.43 | 11 | 35 |
| Kaolin 7 | 25 | 0.37 | 17 | 37 |
| | 50 | 0.34 | 17 | 39 |
| | 100 | 0.32 | 20 | 39 |
| 50/50 | 240 | 0.53 | x | 34 |
| Kaolin 7/CC1 | 300 | 0.56 | x | 37 |
| 50/50 | 100 | 0.56 | x | 32 |
| Kaolin 7/CC3 | 125 | 0.54 | x | 33 |

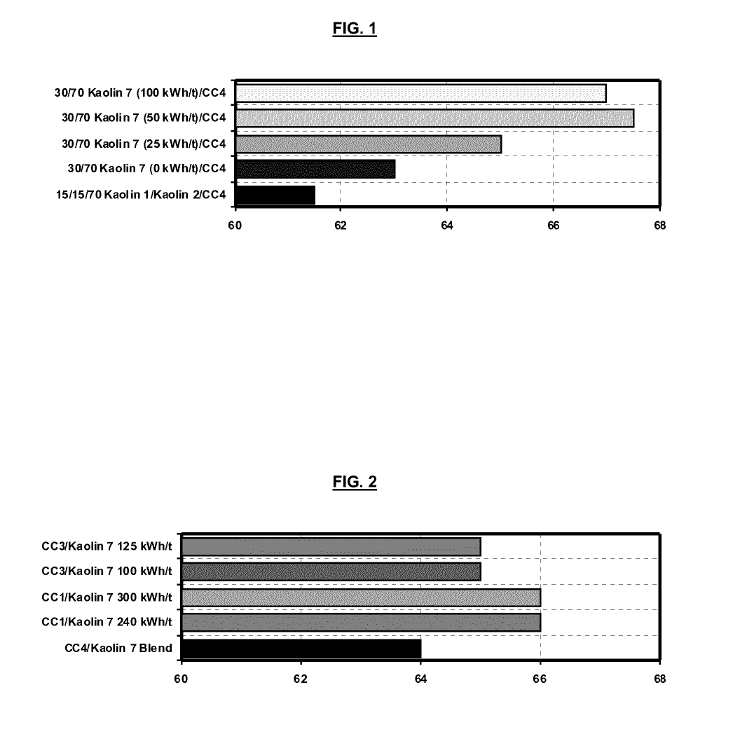

The 70/30 Blend of CC4 and Kaolin 7 ground at different input energies, was evaluated for the sheet gloss of a paper coating at 8 g/m². The results are set forth in FIG. 1.

The co-ground 50/50 CC1/Kaolin 7 product, ground at different energies, was evaluated for the sheet gloss of a paper coating at 8 g/m². The results are set forth in FIG. 2.

It is seen that lightly grinding the Kaolin 7 improves the coated paper properties, especially sheet gloss.

Slightly better performance was obtained when starting with a CC1/Kaolin 7 blend compared to a CC3/Kaolin 7 blend, The kaolin may have more time and energy to be ground finer and calcium carbonate might have a slightly steeper PSD.

Co-grinding with 25% more energy did not result in any further improvements.

### Example 5

Co-ground blends of calcium carbonate and Kaolin 8, the blends having the characteristics shows in Table 9, were evaluated for their use in matt paint. The results are set forth in Table 5.

TABLE 5

| | Work | | | | | | | | | | |
|---|---|---|---|---|---|---|---|---|---|---|---|
| | Input | Particle Size | | | | | | d₅₀ | | | |
| Sample | (kWht) | +10μ | 10 | 2 | 1 | 0.5 | 0.25 | (μ) | Steepness | B'ness | Shape |

70/30 Co-ground Blend of CC1/Kaolin 8

| | | | | | | | | | | | |
|---|---|---|---|---|---|---|---|---|---|---|---|
| CC1 | 0 | 1.0 | 99.0 | 63 | 40 | 23 | 11 | 1.49 | 28 | 94.9/1.7 | |
| Kaolin 8 | 0 | 0.5 | 99.5 | 77 | 59 | 40 | 20 | 0.76 | 25 | 85.5/4.5 | 30 |
| Blend | 100 | 0.9 | 99.1 | 96 | 71 | 39 | 20 | 0.68 | 39 | 88.7/3.2 | |
| Kaolin Fraction | | 0.5 | 99.5 | 94 | 79 | 53 | 27 | 0.49 | 36 | 84.3/3.9 | 36 |
| Carbonate | | | 98.9 | 97 | 68 | 33 | 17 | 0.77 | 40 | | |
| Fraction | | | | | | | | | | | |
| Blend | 200 | 0.5 | 99.5 | 100 | 87 | 53 | 26 | 0.49 | 41 | 89.7/1.7 | |
| Kaolin Fraction | | 0.2 | 99.8 | 97 | 87 | 62 | 34 | 0.41 | 43 | 83.3/3.6 | 29 |
| Carbonate | | | 99.4 | 100 | 87 | 49 | 23 | 0.52 | 40 | | |
| Fraction | | | | | | | | | | | |
| Blend | 300 | 0.9 | 99.1 | 100 | 94 | 63 | 36 | 0.40 | 38 | 90.1/1.5 | |
| Kaolin Fraction | | 0.2 | 99.8 | 99 | 92 | 69 | 37 | 0.36 | 40 | 82.7/3.3 | 23 |
| Carbonate | | | 98.8 | 100 | 95 | 60 | 36 | 0.42 | 37 | | |
| Fraction | | | | | | | | | | | |

70/30 Co-ground Blend of CC3/Kaolin 8

| | | | | | | | | | | | |
|---|---|---|---|---|---|---|---|---|---|---|---|
| CCS | 0 | 1.0 | 99.0 | 90 | 62 | 37 | 19 | 0.78 | 33 | 94.9/1.4 | |
| Kaolin 8 | 0 | 0.5 | 99.5 | 77 | 59 | 40 | 20 | 0.76 | 25 | 85.5/4.5 | 30 |
| Blend | 100 | 0.2 | 99.8 | 98 | 80 | 48 | 28 | 0.55 | 36 | 90.7/1.8 | |
| Kaolin Fraction | | 0.1 | 99.9 | 95 | 80 | 54 | 27 | 0.48 | 38 | 83.6/3.6 | 39 |
| Carbonate | | | 99.8 | 99 | 80 | 45 | 28 | 0.58 | 35 | | |
| Fraction | | | | | | | | | | | |
| Blend | 200 | 0.7 | 99.3 | 100 | 91 | 60 | 33 | 0.43 | 38 | 88.5/2.3 | |
| Kaolin Fraction | | 0.0 | 100.0 | 98 | 89 | 64 | 31 | 0.40 | 45 | 83.3/3.2 | 29 |
| Carbonate | | | 99.0 | 100 | 92 | 58 | 34 | 0.44 | 35 | | |
| Fraction | | | | | | | | | | | |
| Blend | 300 | 0.0 | 100.0 | 100 | 95 | 69 | 38 | 0.36 | 35 | 87.1/2.2 | |
| Kaolin Fraction | | 0.1 | 99.9 | 99 | 93 | 70 | 35 | 0.36 | 43 | 82.4/3.0 | 43 |
| Carbonate | | | 100.0 | 100 | 96 | 69 | 39 | 0.36 | 32 | | |
| Fraction | | | | | | | | | | | |

It is seen that, with increasing grinding energy, d₅₀ reduces and PSD steepness increases.

When Kaolin 8 is added to the coarser CC1, the particle shape reduces, but increases when added to the CC3.

### Example 6

Co-ground calcium carbonate and kaolin was evaluated for use in a low TiO₂ matt paint formulation. The results are set forth in Table 6.

TABLE 6

| | CC1/Kaolin 8 |
|---|---|
| | Co-ground @ 200 kWh/t |
| Rheology | |
| Gel Strength, g cm | 20 |
| Brookfield 1 rpm, Poise | 750 |
| 10 rpm, Poise | 110 |
| 100 rpm, Poise | 21.2 |
| Stormer Krebs, Krebs | 95.1 |
| Rotothinner, Poise | 5.0 |
| Cone and Plate, Poise | 0.9 |
| Dry Film Properties | |
| Dry Contrast Ratio at 60 μm, % | 94.2 |
| Dry Hiding @ 20 m²l⁻¹, % | 91.4 |
| S, mm−1 | 81.7 |
| K, mm−1 | 0.55 |
| L* | 95.60 |
| a* | −0.40 |
| b* | 1.61 |
| Gloss at 85, % | 3.8 |
| Gilsonite Stain Resistance | 88 |
| Mud Crack Resistance, μm | 900 |
| BS Scrub at 40 cycles, mg/cm₂, | 3.87 |
| 7 days drying @ 23° C. | |

### Example 7

Three talc products and a particulate ground calcium carbonate were each ground separately in a laboratory stirred mill grinder at high solids using two different energy levels with medium-size high-density media (8/14).

Talc A is a talc having a shape factor of 21, a d₅₀ of 8.36 μm and a wt % smaller than 2 μm of 45%. Talc A was ground at 60 wt % solids.

Talc B is a talc having a shape factor of 20, a d₅₀ of 7.55 μm and a wt % smaller than 2 μm of 13%. Talc B was ground at 57 wt % solids.

Talc C is a talc having a shape factor of 39, a d₅₀ of 2.96 μm and a wt % smaller than 2 μm of 35%. Talc A was ground at 60wt % solids.

C60 is a ground marble having a d₅₀ of 1.37 μm and a wt % smaller than 2 μm of 62%. C60 was ground at 72 wt % solids.

The results obtained are set forth in Table 7, as follows:

TABLE 7

| | |
|---|---|
| Grinding | |
| Energy | Sedigraph |

| | (kWh/t) | Shape Factor | <2 μm (%) | d₅₀ (μm) |
|---|---|---|---|---|
| Talc A | — | 21 | 13 | 8.36 |
| | 125 | 64 | 25 | 5.85 |
| | 250 | 71 | 35 | 2.78 |
| Talc B | — | 20 | 13 | 7.55 |
| | 125 | 63 | 26 | 3.68 |
| | 250 | 70 | 35 | 2.8 |
| Talc C | — | 39 | 35 | 2.96 |
| | 125 | 52 | 39 | 2.3 |
| | 250 | 55 | 48 | 2.05 |
| C60 | — | — | 62 | 1.37 |
| | 125 | — | 89 | 0.78 |
| | 250 | — | 97 | 0.54 |

Each of Talcs A, B and C was then ground with the Carbonate C60 in a 75/25 marble/talc blend. Grinding was performed at 65 wt % solids and at two different grinding energy levels with the same medium-size high-density media (8/14) as used above. The results obtained are set forth in Table 8 below.

TABLE 8

| | | | | Carbonate | | | | |
|---|---|---|---|---|---|---|---|---|
| | Grinding | Blend | | component | | Talc component | | |
| | Energy | <2 μm | d₅₀ | <2 μm | d₅₀ | <2 μm | d₅₀ | Shape |
| | kWh/t | (%) | (μm) | (%) | (μm) | (%) | (μm) | Factor |
| Talc A/C60 | 125 | 73 | 1.09 | 82 | 0.91 | 48 | 2.14 | 53 |
| | 250 | 84 | 0.81 | 90 | 0.72 | 65 | 1.28 | 43 |
| Talc B/C60 | 125 | 75 | 1.02 | 83 | 0.85 | 49 | 2.05 | 52 |
| | 250 | 83 | 0.78 | 89 | 0.69 | 66 | 1.24 | 40 |
| Talc C/C60 | 125 | 78 | 0.95 | 83 | 0.82 | 62 | 1.47 | 34 |
| | 250 | 91 | 0.65 | 97 | 0.56 | 75 | 1.01 | 20 |

The particle size and shape factor of the individual components of the ground blend can be determined by removing the carbonate component of the co-ground blend by dissolving it using acid (for example hydrochloric acid) and then washing the remaining product until it is free of excess ions. The particle size characteristics of the phyllosilicate component of the ground blend can then be measured. Based on the particle size characteristics of the ground blend as a whole, the particle size characteristics of the carbonate can be calculated

1-33. (canceled)

34. A method for grinding a particulate inorganic material, comprising:
providing an aqueous suspension comprising a mixture of a particulate alkaline earth metal carbonate material and a particulate phyllosilicate mineral having a shape factor less than 60; and
grinding the aqueous suspension to form a ground product.

35. A method according to claim 34, wherein the solids content of the aqueous suspension is at least 25% by weight.

36. A method according to claim 34, wherein the shape factor of the phyllosilicate mineral in the product is less than 125 or less than 100.

37. A method according to claim 34, wherein the alkaline earth metal carbonate is calcium carbonate.

38. A method according to claim 34, wherein the alkaline earth metal carbonate material has a d₅₀ in the range of from 0.5 to 5 μm.

39. A method according to claim 34, wherein the phyllosilicate mineral is selected from the group consisting of kaolin, talc, and mica.

40. A method according to claim 39, wherein the phyllosilicate mineral is kaolin.

41. A method according to claim 40, wherein the shape factor of the kaolin in the aqueous suspension is from 5 to 60.

42. A method according to claim 40, wherein the d₅₀ of the kaolin in the aqueous suspension is in the range of from 0.3 to 10 μm.

43. A method according to claim 40, wherein the shape factor of the kaolin in the product is from 5 to 100.

44. A method according to claim 40, wherein the d₅₀ of the kaolin in the product is in the range of from 0.1 to 5 μm.

45. A method according to claim 39, wherein the phyllosilicate mineral is talc.

46. A method according to claim 45, wherein the shape factor of the talc in the aqueous suspension is from 15 to 40.

47. A method according to claim 45, wherein the d₅₀ of the talc in the aqueous suspension is in the range of from 2 to 20 μm.

48. A method according to claim 45, wherein the shape factor of the talc in the product is from 10 to 150.

49. A method according to claim 45, wherein the d₅₀ of the talc in the product is in the range of from 0.5 to 10 μm.

50. A method according to claim 39, wherein the phyllosilicate mineral comprises kaolin and talc.

51. A method according to claim 34, wherein the ratio of the weight of alkaline earth metal carbonate material to the weight of the phyllosilicate mineral in the aqueous suspension is from 5:95 to 95:5.

52. A method according to claim 34, wherein the solids content of the aqueous suspension is greater than 70% by weight.

53. A method according to claim 34, wherein the grinding energy input during grinding is at least 25 kWh/t.

54. A method according to claim 34, wherein grinding is carried out in a tumbling mill, a stirred mill, or a stirred media detritor.

55. A method according to claim 34, wherein the aqueous suspension comprises a mixture of calcium carbonate and kaolin in a weight ratio of from 5:95 to 95:5, wherein the calcium carbonate has a d₅₀ in the range of from 0.5 to 5 μm, and the kaolin has a shape factor of from 5 to 60 and a d₅₀ of from 0.3 to 10 μm.

56. A method according to claim 55, wherein the calcium carbonate in the product has a d₅₀ in the range of from 0.1 to 5 μm, and the kaolin in the product has a d₅₀ in the range of from 0.1 to 5 μm and a shape factor of from 5 to 100.

57. A method according to claim 34, wherein the aqueous suspension comprises a mixture of calcium carbonate and talc in a weight ratio of from 5:95 to 95:5, wherein the calcium carbonate has a d₅₀ in the range of from 0.5 to 5 μm, and the talc has a shape factor of from 5 to 50 and a d₅₀ of from 2 to 20 μm.

58. A method according to claim 57, wherein the calcium carbonate in the product has a d₅₀ in the range of from 0.1 to 5 μm, and the talc in the product has a d₅₀ in the range of from 0.5 to 10 μm and a shape factor of from 10 to 150.

59. A method according to claim 34, wherein the steepness of the particulate alkaline earth metal carbonate material in the product is increased.

60. A method according to claim 34, wherein the phyllosilicate mineral is kaolin and the grinding is carried out such that the shape factor of the kaolin in the ground product is reduced, and the d₅₀ of the kaolin is reduced in the grinding step by at least 20%.

61. A method according to claim 34, wherein the phyllosilicate mineral is talc and the grinding is carried out such that the shape factor of the talc in the ground product is increased, and the d₅₀ of the talc is reduced in the grinding step by at least 40%.

62. A method according to claim 34, wherein the phyllosilicate mineral is talc and the grinding is carried out such that the shape factor of the talc in the ground product is reduced, and the d₅₀ of the talc is reduced in the grinding step by at least 20%.

63. A ground particulate material comprising an alkaline earth metal carbonate and a phyllosilicate material obtainable by a method as claimed in claim 34.

64. A ground particulate material comprising an alkaline earth metal carbonate and kaolin, wherein the calcium carbonate has a d₅₀ in the range of from 0.1 to 5 μm, and the kaolin has a d₅₀ in the range of from 0.1 to 5 μm and a shape factor of from 5 to 100.

65. A ground particulate material according to claim 64, wherein the steepness of the particulate alkaline earth metal carbonate material is from 25 to 55.

66. A ground particulate material comprising an alkaline earth metal carbonate and talc, wherein the calcium carbonate has a d₅₀ in the range of from 0.1 to 5 μm, and the talc has a d₅₀ in the range of from 0.5 to 10 μm and a shape factor of from 10 to 100.

67. A ground particulate material according to claim 66, wherein the steepness of the particulate alkaline earth metal carbonate material is from 25 to 55.
